(19) United States
(12) Patent Application Publication
(10) Pub. No.: US 2021/0342475 A1
(43) Pub. Date: Nov. 4, 2021

(54) CONTROL APPARATUS, DATA ANALYSYS SYSTEM, CONROL METHOD, AND COMPUTER PROGRAM

(71) Applicant: NEC Corporation, Minato-ku, Tokyo (JP)

(72) Inventor: Takao TAKENOUCHI, Tokyo (JP)

(73) Assignee: NEC Corporation, Minato-ku, Tokyo (JP)

(21) Appl. No.: 17/258,945

(22) PCT Filed: Jul. 18, 2018
(86) PCT No.: PCT/JP2018/026979

§ 371 Date: Jan. 8, 2021

(51) Int. Cl. G06F 21/62; H04L 9/08

(52) U.S. Cl. CPC G06F 21/6245; H04L 9/008; H04L 9/085

(57) ABSTRACT

A control apparatus includes a requesting part that requests each of a first apparatus holding identification information of a first moving body(ies) obtained at a first location and a second apparatus holding identification information of a second moving body(ies) obtained at a second location to provide the identification information of the first moving body(ies) and the identification information of the second moving body(ies) to a predetermined secret calculation server(s); and an instruction part that instructs calculation processing relating to movement of a moving body(ies) based on the identification information of the first moving body(ies) and the identification information of the second moving body(ies) to the predetermined secret calculation server(s).

### FIELD

The present invention relates to a control apparatus, a data analysis system, a control method, and a computer program.

### BACKGROUND

Patent Literature (PTL) 1 discloses a system which can confirm safety of a person even if the person oneself does not aware that the person is being searched for as a missing person. According to PTL 1, a pair of a feature amount(s) of a face of the person oneself and personal information of the person oneself or a person requesting confirmation of the person oneself (e.g., a telephone number) is registered in a data base of a portal server 4 by the person requesting confirmation. A field server 2 always collates a captured facial feature amount(s) with a database, and if a similar feature amount(s) is found, brings the registered personal information to prompt confirmation to a person whose image was taken. Furthermore, PTL 1 introduces a template protection technology which can only collate between pieces of biological information of the same person and makes it difficult to divert to other uses and collect statistical information, or the like.

PTL 2 discloses a human body detection and trace system, when tracing the movement of a person in a defined use area for passage, which automatically reads and obtains a bodily feature(s) for each person and can identify and trace the same person.

Non-Patent Literature (NPL) 1 discloses a guidebook which summarizes items to be considered when handling camera images, which is published by Ministry of Economy, Trade and Industry. According to NPL 1, the feature amount data obtained by images taken by a surveillance camera or the like corresponds to personal information as a general rule.

### CITATION LIST

### Patent Literature

PTL 1: WO2015/151155A1

PTL 2: Japanese Patent Kokai Publication No. JP-H11-175730A

### Non-Patent Literature

NPL 1: Ministry of Economy, Trade and Industry, “Camera image usage and application guidebook”, [online] [searched on Jun. 26, 2018, internet <(URL: http://www.meti.go.jp/press/2017/03/20180330005/20180330005-1.pdf>

### SUMMARY

### Technical Problem

The following analysis has been given by the present invention. As described in NPL 1, it is expected that usage and application of data utilizing image taken by surveillance cameras and security cameras will become widespread. However, feature amount data obtained from images taken by such cameras are absolutely personal information, which is strictly warned to be provided to a third party without prior consent of a person concerned.

On the one hand, in a flow line analysis (people flow analysis), it is not important to identify an individual and grasp movement of the individual, but information in such an extent how many users among users at one point were moved to another point is sufficiently of value. If the above described problem for personal information can only be avoided, it is said that it is possible to share a result of the flow line analysis (people flow analysis) by different management entities. Moreover, it is thought that application is not only limited to design a store but also to be useful for urban development and anti-crime measures, or the like.

Furthermore, the above are not only limited to images taken by surveillance cameras and security cameras but also are generally applied to biological information such as fingerprint data and iris data obtained for a particular purpose by various organizations. For example, by collating fingerprint data obtained at the time of entering a facility A with fingerprint data obtained at the time of entering another facility B, information that a particular person has moved from the facility A to the facility B is obtained. This can become the same information as the above described flow line analysis by the feature amount data of the camera. Besides, the target of such flow line analysis is not only limited to humans but also is thought to be appliable to vehicles and animals or the like. Hereinafter, these feature amount data and biological information, and information which can identify the individuals and so on is referred to as “identification information of a moving body.”

It is an object of the present invention to provide a control apparatus, a data analysis system, a control method, and a computer program that can contribute to promote utilization of identification information of a moving body(ies) collected by above described different management entities.

### Solution to Problem

According to a first aspect, there is provided a control apparatus, including: a requesting part that requests each of a first apparatus holding identification information of a first moving body(ies) obtained at a first location and a second apparatus holding identification information of a second moving body(ies) obtained at a second location to provide the identification information of the first moving body(ies) and the identification information of the second moving body(ies) to a predetermined secret calculation server(s); and an instruction part that instructs calculation processing relating to movement of a moving body(ies) based on the identification information of the first moving body(ies) and the identification information of the second moving body(ies) to the predetermined secret calculation server(s).

According to a second aspect, there is provided a data analysis system, including: a predetermined secret calculation server(s); and an above described control apparatus.

According to a third aspect, there is provided a secret calculation server control method, including: requesting each of a first apparatus holding identification information of a first moving body(ies) obtained at a first location and a second apparatus holding identification information of a second moving body(ies) obtained at a second location to provide the identification information of the first moving body(ies) and the identification information of the second moving body(ies) to a predetermined secret calculation server(s); and instructing calculation processing relating to movement of a moving body(ies) based on the identification information of the first moving body(ies) and the identification information of the second moving body(ies) to the predetermined secret calculation server(s). The present method is tied to a particular machine, namely, a control apparatus that obtains desired calculation result using a secret calculation server(s).

According to a fourth aspect, there is provided a computer program that causes a control apparatus to execute processings, including: requesting each of a first apparatus holding identification information of a first moving body(ies) obtained at a first location and a second apparatus holding identification information of a second moving body(ies) obtained at a second location to provide the identification information of the first moving body(ies) and the identification information of the second moving body(ies) to a predetermined secret calculation server(s); and instructing calculation processing relating to movement of a moving body(ies) based on the identification information of the first moving body(ies) and the identification information of the second moving body(ies) to the predetermined secret calculation server(s). It is to be noted that this program may be recorded on a computer-readable (non-transitory) storage medium. That is to say, the present invention may be implemented as a computer program product. Advantageous Effects of Invention

According to the present invention, it is possible to promote utilization of identification information of a moving body(ies) collected by different management entities.

### BRIEF DESCRIPTION OF DRAWINGS

FIG. 1 illustrates a configuration according to an exemplary embodiment of the present invention.

FIG. 2 illustrates a configuration of a data analysis system accordig to a first exemplary embodiment of the present invention.

FIG. 3 illustrates a configuration of a firtst apparatus of the data analysis system accordig to the first exemplary embodiment of the present invention.

FIG. 4 illustrates an example of data which the firtst apparatus of the data analysis system holds accordig to the first exemplary embodiment of the present invention.

FIG. 5 illustrates a configuration of a control apparatus of the data analysis system accordig to the first exemplary embodiment of the present invention.

FIG. 6 illustrates a sequence diagram showing an operation of the data analysis system accordig to the first exemplary embodiment of the present invention.

FIG. 7 illustrates an example of a man-flow analysis processing by the data analysis system accordig to the first exemplary embodiment of the present invention.

FIG. 8 illustrates another example of a man-flow analysis processing by the data analysis system accordig to the first exemplary embodiment of the present invention.

FIG. 9 illustrates other example of a man-flow analysis processing by the data analysis system accordig to the first exemplary embodiment of the present invention.

FIG. 10 illustrates an example of an analysis result by the data analysis system accordig to the first exemplary embodiment of the present invention.

FIG. 11 illustrates a configuration of a data analysis system accordig to a second exemplary embodiment of the present invention.

FIG. 12 illustrates a configuration of a firtst apparatus of the data analysis system accordig to the second exemplary embodiment of the present invention.

FIG. 13 illustrates a configuration of a control apparatus of the data analysis system accordig to the second exemplary embodiment of the present invention.

FIG. 14 illustrates a sequence diagram showing an operation of the data analysis system accordig to the second exemplary embodiment of the present invention.

FIG. 15 illustrates an example of data which the firtst apparatus of the data analysis system holds accordig to the second exemplary embodiment of the present invention.

FIG. 16 illustrates an example of data which the firtst apparatus of the data analysis system holds accordig to a third exemplary embodiment of the present invention.

FIG. 17 illustrates a configuration of a variation of a data analysis system accordig to the present invention.

FIG. 18 illustrates a configuration of a computer that configures a control apparatus according to the present invention.

### DESCRIPTION OF EXEMPLARY EMBODIMENTS

First, an outline of an exemplary embodiment of the present invention will be described with reference to drawings. In the following outline, reference signs of the drawings are denoted to each element as an example for the sake of convenience to facilitate understanding and is not intended to limit the present invention to the illustrated modes. An individual connection line between blocks in an individual drawing, etc. referred to hereinafter includes both one-way and two-way directions. A one-way arrow schematically illustrates a principal signal (data) flow and does not exclude bidirectionality. While not illustrated, a port(s) or an interface(s) exists at an input-output connection point(s) in an individual block in the drawings.

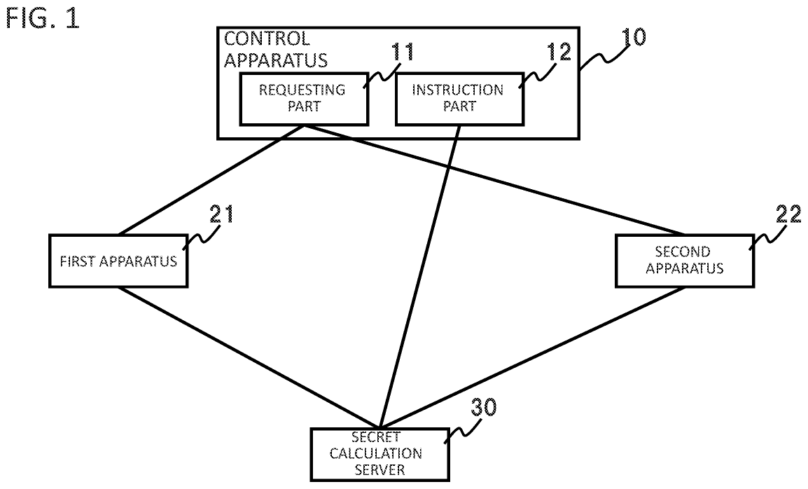

In an exemplary embodiment, as shown in FIG. 1, the present invention can be realized by a control apparatus 10 connected to a first apparatus 21, a second apparatus 22 and a secret calculation server 30. More concretely, the first apparatus 21 holds identification information of a first moving body obtained at a first location. The second apparatus 22 holds identification information of a second moving body obtained at a second location.

Then, a control apparatus 10 includes a requesting part 11 and an instruction part 12. The requesting part 11 requests each of the first apparatus and the second apparatus to provide the identification information of the first moving body and the identification information of the second moving body to a secret calculation server 30.

On the other hand, the instruction part 12 instructs calculation processing relating to movement of a moving body based on the identification information of the first moving body and the identification information of the second moving body to the secret calculation server 30.

As a result of the above, the secret calculation server 30 performs calculation processing relating to movement(s) of a moving body(ies) based on the identification information of the first moving body and the identification information of the second moving body. Hereby, it becomes possible to calculate the number of a moving body(ies) that is(are) presumed to have moved between, for example, the first location and the second location. Then, the calculation processing of the identification information of the first moving body and the identification information of the second moving body is performed, after being properly encrypted, by the secret calculation server, whereby risk of leakage of the identification information of the first moving body and the identification information of the second moving body can be reduced.

### FIRST EXEMPLARY EMBODIMENT

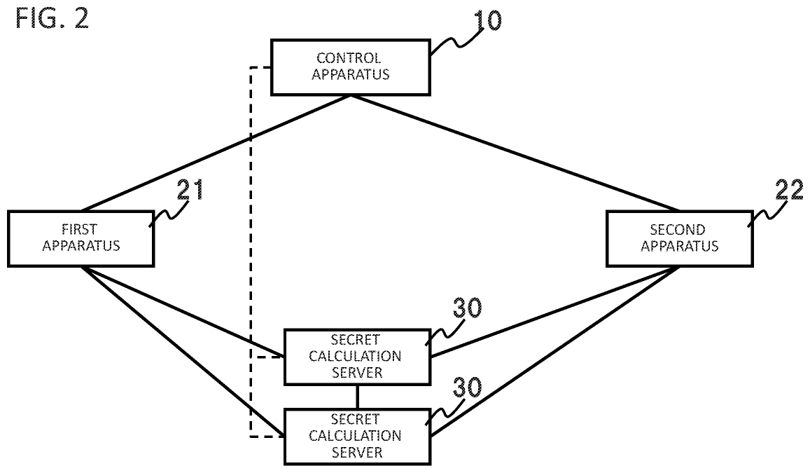

Next, a data analysis system accordig to a first exemplary embodiment of the present invention will be described in detail with reference to drawings. FIG. 2 illustrates a configuration of the data analysis system accordig to the first exemplary embodiment of the present invention.

With reference to FIG. 2, a configuration in which a control apparatus 10 is connected to a first apparatus 21, a second apparatus 22 and two secret calculation servers 30 is shown.

The first apparatus 21 is an apparatus that holds facial feature data of a passenger(s) obtained from an image(s) taken by a camera(s) installed at a station(s) or various facilities as identification information of a first moving body(ies) taken at a first location.

The second apparatus 22 is an apparatus that holds facial feature data of a passenger(s) obtained from an image(s) taken by a camera(s) installed at a station(s) or various facilities different from the first location as identification information of a second moving body(ies) taken at a second location.

It is assumed that the first apparatus 21 and the second apparatus 22 are managed by different management entities each other (including a case where data administrators are different in the same organization). It is assumed that the identification information of the first moving body(ies) and the identification information of the second moving body(ies) are respectively managed and operated in such a manner that data is not leaked to outside. That is, the identification information of the first moving body(ies) and the identification information of the second moving body(ies) are data which were respectively obtained under different management entities and managed under conditions such as being kept inside and discarded after elapse of a predetermined time, and so on.

The two secret calculation servers 30 are servers which respectively receive share information in which the facial feature data is secret-shared from the first apparatus 21 and the second apparatus 22, and perform calculation in a secret sharing scheme.

The control apparatus 10 is an apparatus that causes the first apparatus 21 and the second apparatus 22 to transmit share information to the secret calculation servers 30 and to instruct calculation using the share information and so on to the secret calculation servers 30.

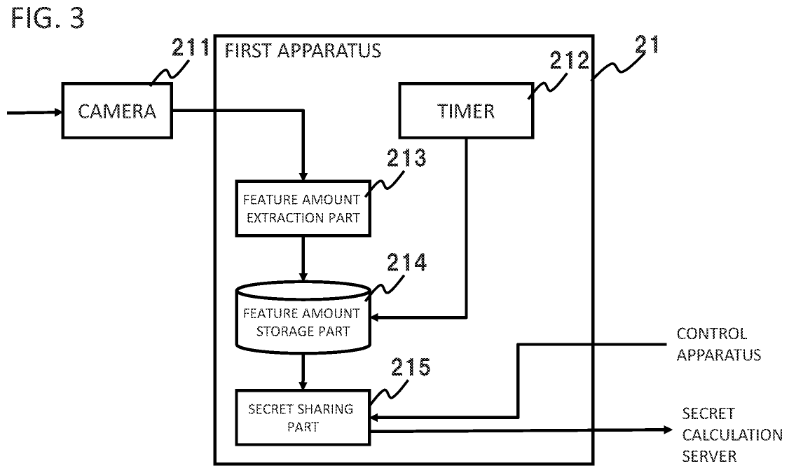

FIG. 3 illustrates a configuration of the firtst apparatus of the data analysis system accordig to the first exemplary embodiment of the present invention. With reference to FIG. 3, a configuration is shown in which the firtst apparatus includes a timer 212, a feature amount extraction part 213, a feature amount storage part 214 and a secret sharing part 215 and is connected to a camera 211.

The camera 211 is a security camera(s) and so on installed at a station(s) or various facilities. The timer 212 is used to record a shooting date and time. In an example of FIG. 3, the number of cameras is one, but the number of cameras is not limited. For example, a configuration in which moving image data can be obtained by switching a camera used for shooting during daytime and a camera used for shooting during night-time, may be employed. Furthermore, for example, a configuration in which a plurality of cameras that have different angles of fields and shooting directions are installed, may be employed.

The feature amount extraction part 213 cuts out an image from the moving image shot by the camera 211 and extracts facial feature data of a person who is caught in the image. In a case where faces of a plurality of persons are included in one image, the feature amount extraction part 213 identifies each region of the faces of the persons of the one image and extracts a plurality of facial feature data.

The feature amount storage part 214 stores the facial feature data extracted by the feature amount extraction part 213 in association with information of a date and time obtained by the timer 212.

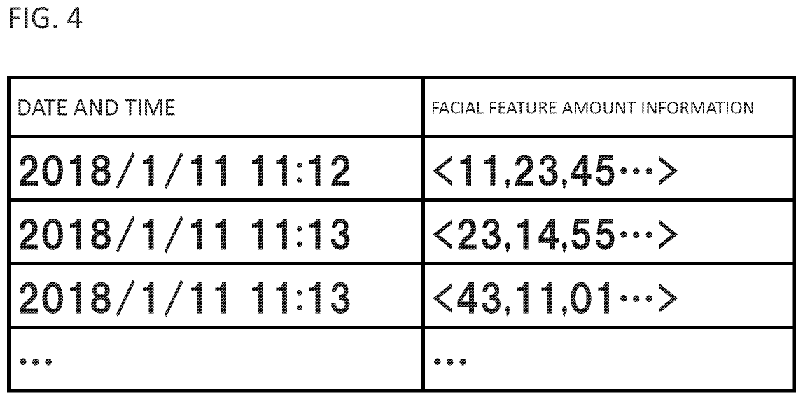

FIG. 4 illustrates an example of facial feature data stored in the feature amount storage part 214. In the example of FIG. 4, an example to store an entry which associates the date and time provided from the timer 212 with the facial feature amount imformation (facial feature data) is shown. The facial feature amount imformation 11, 23, 45, . . . describes a feature vector among predetermined facial features (face nodes).

The secret sharing part 215 extracts the facial feature data from the feature amount storage part 214, generates share information to be transmitted to the secret calculation server(s) 30 and transmits the share information to the secret calculation server(s) 30.

The first apparatus 21 as described above can also be realized by adding the secret sharing part 215 to an apparatus which performs a man-flow analysis using face recognition data in the same organization (facility). Furthermore, because the second apparatus 22 has the same configuration as that of the first apparatus 21 except that the second apparatus 22 has a camera having at least a different shooting area from that of the camera 211, the description will be omitted.

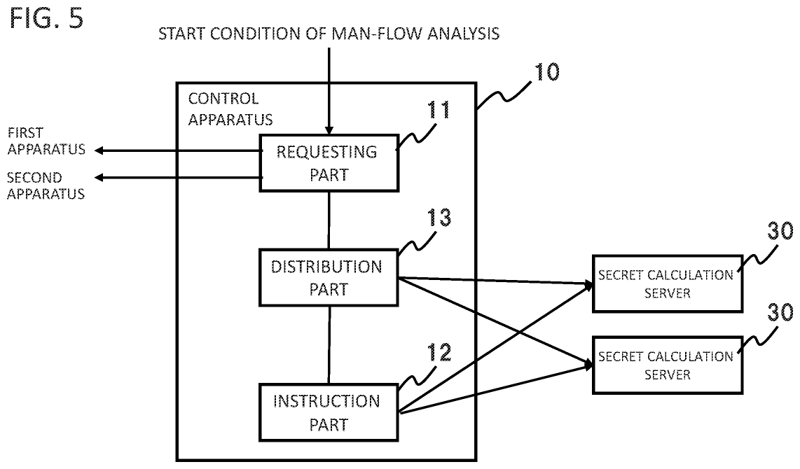

Subsequently, a configuration of a control apparatus 10 will be explained in detail with reference to the drawings. FIG. 5 illustrates a configuration of the control apparatus of the data analysis system accordig to the first exemplary embodiment of the present invention. With reference to FIG. 5, a configuration including a requesting part 11, a distribution part 13 and an instruction part 12 is shown.

The requesting part 11 requests, based on a preset start condition of a man-flow analysis, the first apparatus 21 and the second apparatus to generate share information to be transmitted to the secret calculation servers 30 and transmit the share information. As the start condition of a man-flow analysis, a condition to perform the man-flow analysis with a particular processing precision every fixed time based on moving images shot at a first point and a second point in a past certain period of time is conceivable. Furthermore, the start condition of a man-flow analysis may not only be a periodical start condition as described above, but may also be, for example, reception of an explicit instruction for requiring a temporary man-flow analysis from a user.

The distribution part 13 distributes to the secret calculation servers 30 a secret calculation circuit (secret calculation program) which causes the secret calculation servers 30 to execute secret calculation of contents and a precision corresponding to the start condition of a man-flow analysis described above. The secret calculation circuit (secret calculation program) may be previously prepared or may be generated each time. Furthermore, it is also possible to employ a configuration in which a plurality of secret calculation circuits (secret calculation programs) are distributed to a side of the secret calculation servers 30 in advance and the secret calculation circuit (secret calculation program) corresponding to described contents will be selected at the side of the secret calculation servers 30.

The instruction part 12 instructs execution of secret calculation processing to the secret calculation servers 30 at a moment when the generation and transmission of the share information by the requesting part 11 are finished.

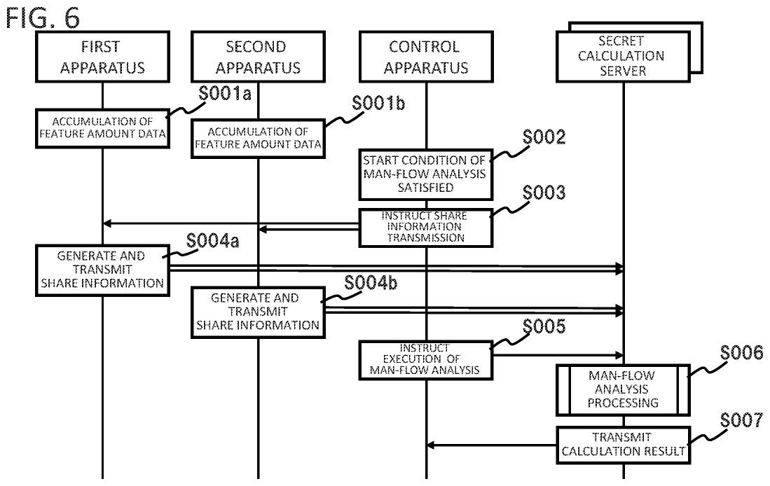

Subsequently, an operation of the present exemplary embodiment will be described in detail with reference to the drawings. FIG. 6 illustrates a sequence diagram showing an operation of the data analysis system accordig to the first exemplary embodiment of the present invention. In the following description, it is assumed that distribution of the secret calculation circuit (program) by the distribution part 13 has been completed.

With reference to FIG. 6, first, feature amount data (facial feature data) is accumulated in the first apparatus 21 and the second apparatus 22, respectively (steps S001a, S001b).

Then, in a case where a predetermined start condition of a man-flow analysis is satisfied (step S002), the control apparatus 10 instructs the first apparatus 21 and the second apparatus 22 respectively to transmit share information to the secret calculation servers 30 (step S003).

The first apparatus 21 and the second apparatus 22, based on an instruction from the control apparatus 10, extract the facial feature data from the feature amount storage part 214, generate share information to be transmitted to the secret calculation servers 30, and transmit the share information to the secret calculation servers 30, respectively (steps S004a, S004b).

Next, the control apparatus 10 instructs execution of the man-flow analysis by the share information to the secret calculation servers 30 (step S005).

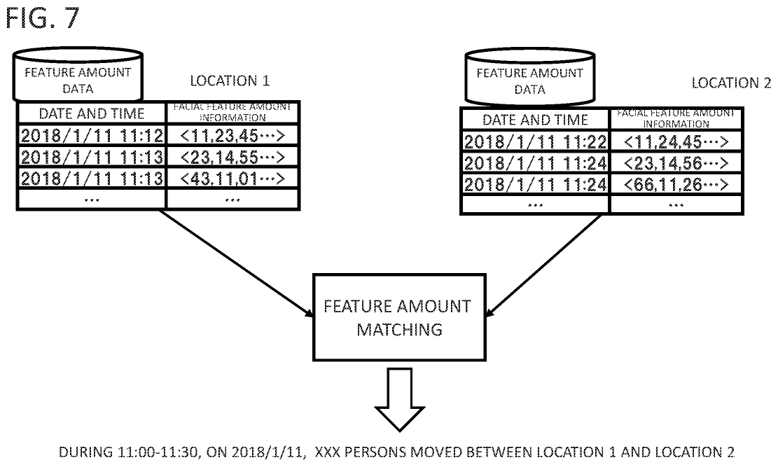

Next, the secret calculation servers 30 which received the instruction of the execution of the secret calculation execute the man-flow analysis processing by the share information in cooperation with each other (step S006). Concrete example of the man-flow analysis processing will be described later in detail with reference to FIG. 7 to FIG. 10.

Finally, the secret calculation servers 30 transmit results (calculation results) of the man-flow analysis to the control apparatus 10 (step S007). In the example shown in FIG. 6, although the secret calculation servers 30 is to transmit the results (calculation results) of the man-flow analysis to the control apparatus 10, the result (calculation result) of the man-flow analysis may be transmitted to a destination other than the control apparatus 10. For example, the result (calculation result) of the man-flow analysis may be transmitted to the first apparatus 21 and the second apparatus 22 which are sources of the facial feature data. As a result, a management entity of the first apparatus 21 and the second apparatus 22 can utilize the results for the operation of facility and improvement of a signpost for visitors based on the result (calculation result) of the man-flow analysis.

Furthermore, the management entity of the first apparatus 21 and the second apparatus 22 can obtain the result (calculation result) of the man-flow analysis without providing the facial feature data to each other.

Subsequently, a concrete example of the man-flow analysis in above step S006 will be described.

### [Aggregation of the Number of Moved Persons]

FIG. 7 illustrates an example for matching a person who emerged in a camera at a location 1 and a person who emerged in a camera at a location 2. For example, as shown in FIG. 7, the number of persons moved between the location 1 and the locaion 2 can be calculated by collating the facial feature data during 11:00-11:30 on 2018/1/11. By using the secret sharing scheme, it is possible to cause the individual secret calculation server 30 to perform desired calculation processing without restoring original facial feature data. For example, in a case where the location 1 is an A station and the location 2 is a B ballpark (B stadium), respective management entities can obtain a result that XX persons have moved from the A station to the B ballpark (B stadium) while keeping the facial feature data obtained at the A station and the facial feature data obtained at the B ballpark (B stadium) secret.

Furthermore, it is also possible to sell the aggregation result of the number of moved persons for a fee to the third party because the aggregation result of the number of moved persons does not contain personal information. The matching of the facial feature data can be performed by obtaining a distance between two feature vectors and comparing the value with a predetermined threshold value.

### [Aggregation of Required Time]

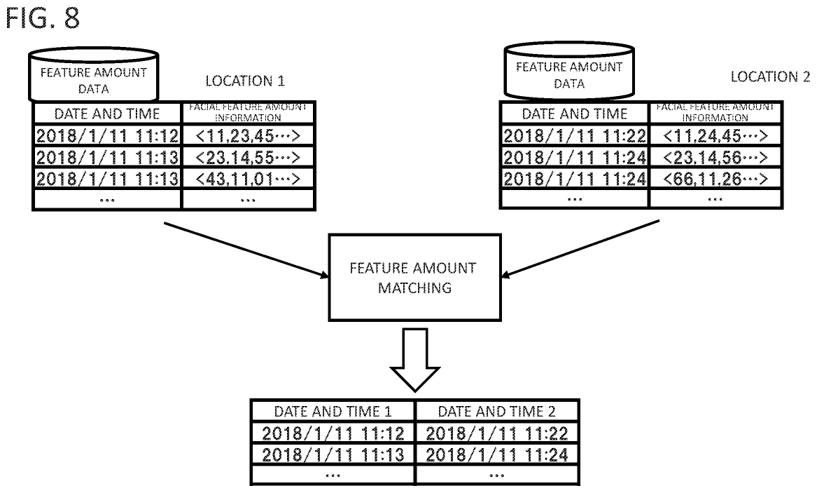

FIG. 8 shows an example of performing aggregation of required time by matching a person who emerged in a camera at a location 1 and a person who emerged in a camera at a location 2 and combining data. For example, as shown in FIG. 8, it is possible to identify a person who emerged at both the location 1 and the location 2 by collating facial feature data during a particular period of time. Then, it is possible to obtain a time-length required for the person to move between the location 1 and the loation 2 from a difference between times when the person was shot. Similarly, for example, in a case where the location 1 is an A station and the location 2 is a B ballpark (B stadium), respective management entities can obtain a result that an average required time-length of a person moved from the A station to the B ballpark (B stadium) is XX minutes while keeping the respectively managed facial feature data secret. Furthermore, it is possible to sell the aggregation result of the required time-length for a fee to the third party because personal information is not included. Furthermore, it is preferable that, as shown in FIG. 8, facial feature data is removed from combined data so that an individual cannot be identified.

### [Man-Flow Analysis]

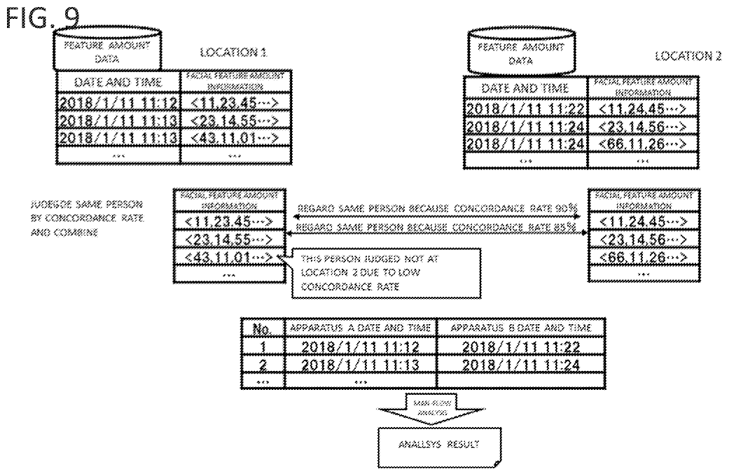

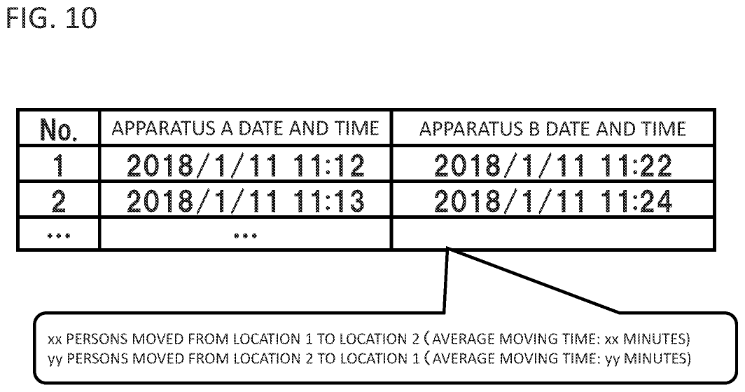

FIG. 9 shows an example of generating a list of required time-length for each person by matching a person who emerged in a camera at a location 1 and a person who emerged in a camera at a location 2 and combining data. Furthermore, in the example shown in FIG. 9, an execution result of man-flow analysis is generated from the generated list of the required time-length for each person. In the example of an execution result of man-flow analysis shown in FIG. 10, it becomes possible to obtain information such as the number of persons moved between the location 1 and the locaion 2 and an average moving time-length thereof by using the list of required time-length for each person. In the present case, as shown in FIG. 9 and FIG. 10, it is preferable that the facial feature data is removed from the analysis result and processing is done so that an individual cannot be identified by anonymization processing such as No. 1 and No. 2 and so on. Similarly, for example, in a case where the location 1 is an A station and the location 2 is a B ballpark (B stadium), respective management entities can obtain a result that XX persons have moved from the A station to the B ballpark (B stadium) and an average required time-length thereof is XX minutes while keeping the respectiely managed facial feature data secret. Then, such information can be utilized for safty by optimal allocation of security gards and guides, hospitality, and tourism and urban development based on an analysis of a trend in behavior of visitors, and so on. Therefore, it can be said that the data analysis system of the present invention functions as a system capable of performing various analysis relating to movement of a moving body(ies).

The threshold value for determining as an identical person (concordance rate) in above FIG. 7 to FIG. 9 can be properly set according to a required precision and resolution of a camera and so on. For example, in FIG. 9, it is possible to determine as an identical person when a concordance rate more than or equal to 85% is obtained, but when more strict determination is required, it may be possible to determine as an identical person when the concordance rate is more than or equal to 90%. Furthermore, in a case where the resolution of a camera is low or image quality is lowered because a shooting place is dark, it is possible to determine as an identical person when the concordance rate is more than or equal to 70%. In this way, a threshold value (concordance rate) can be adjusted according to the precision (quality) of facial feature data or precision of a required analysis result and so on.

In the above described example, it is described that facial feature data is stored in association with the date and time information, but facial feature data may not be individually associated with the date and time information. For example, it may be configured that facial feature data identified during a certain period of time can be held in the feature amount storage part 214.

### SECOND EXEMPLARY EMBODIMENT

Next, a second exemplary embodiment, in which processing contents of secret calculation servers can be switched according to a processing speed required for man-flow analysis and a processing precision of man-flow analysis and so on, will be described in detail with reference to the drawings.

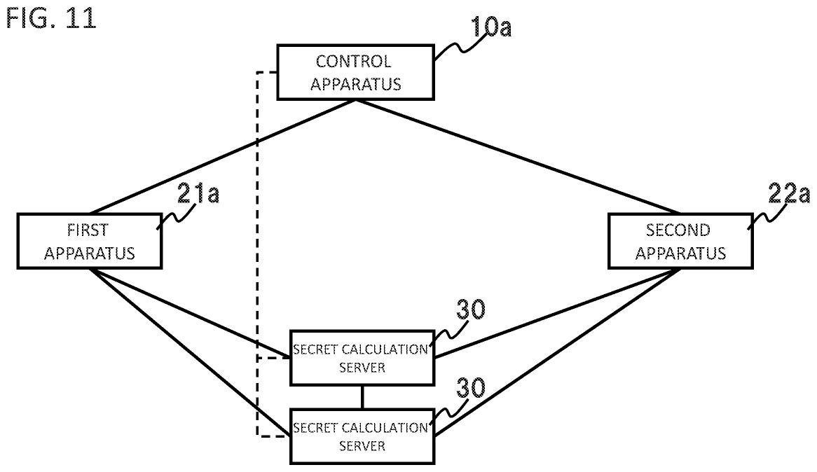

FIG. 11 illustrates a configuration of a data analysis system according to the second exemplary embodiment of the present invention.

Difference in a configuration from that of the first exemplary embodiment shown in FIG. 2 is that a function to change the number of digits of facial feature data is added to a first apparatus 21a and a second apparatus 22a, and a function to instruct to change the number of digits of facial feature data and a function to instruct secret calculation according to the number of digits are added to a control apparatus 10a. An instruction to change the number of digits by the function to instruct to change the number of digits is to instruct truncation of a value less than or equal to a designated digit of a feature vector of facial feature data.

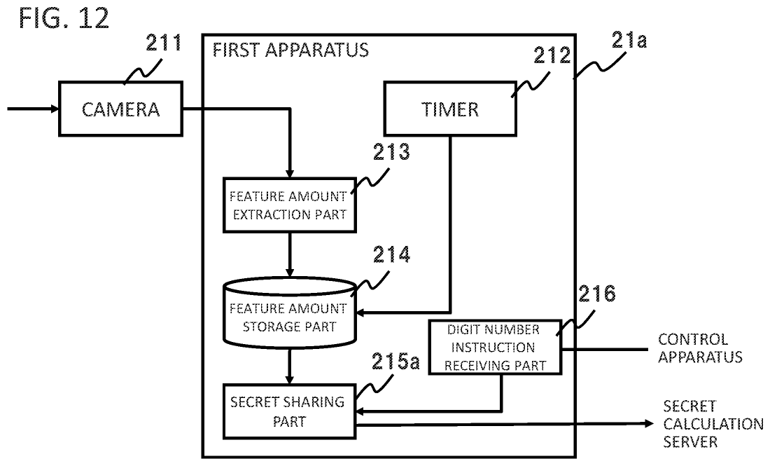

FIG. 12 illustrates a configuration of a first apparatus 21a of the data analysis system according to the second exemplary embodiment of the present invention. Difference thereof from the first apparatus of the first exemplary embodiment shown in FIG. 3 is that a digit number instruction receiving part 216 is added and a secret sharing part 215a generates share information from facial feature data of the designated number of digits and transmits the share information. Because other configuration is the same as that of the first exemplary embodiment, difference will be mainly described as below.

When a share information transmission instruction with a digit number instruction is received from the control apparatus 10a, the digit number instruction receiving part 216 transmits the share information transmission instruction with the digit number instruction to a secret sharing part 215a.

When the share information transmission instruction with the digit number instruction is received, the secret sharing part 215a extracts facial feature data from the feature amount storage part 214 and performs processing to reduce the number of the digits of its feature vector. Then, the secret sharing part 215a generates share information to be transmitted to the secret calculation servers 30 from facial feature data whose number of the digits is reduced, and transmits the share information to the secret calculation servers 30.

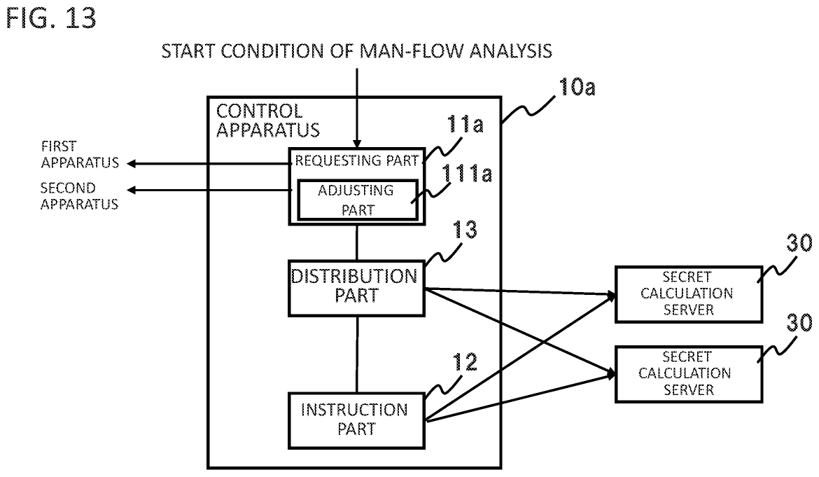

Subsequently, a configuration of a control apparatus 10a will be described in detail with reference to the drawings. FIG. 13 illustrates a configuration of a control apparatus 10a according to the second exemplary embodiment of the present invention. Difference from the control apparatus of the first exemplary embodiment shown in FIG. 5 is that the requesting part lla transmits a share information transmission instruction having a digit number instruction to a first apparatus and a second apparatus. Because other configuration is the same as that of the first exemplary embodiment, difference will be mainly described as below.

A requesting part 11a of the present exemplary embodiment further includes an adjusting part 111a which determines the number of digits to be designated in a share information transmission instruction according to a start condition of a man-flow analysis and a processing speed of a man-flow analysis supplied separately. Then, the requesting part 11a transmits a share information transmission instruction in which the determined number of digits is designated to the first apparatus 21a and the second apparatus 22a. For example, it is assumed that a required time-length of a man-flow analysis is 30 minutes when the number of digits is not reduced whereas a processing speed (required time-length) of a man-flow analysis required from a user is 15 minutes. In such case, the requesting part 11a instructs the first apparatus 21a and the second apparatus 22a to generate share information for which the number of significant digits of a facial feature vector of facial feature date is reduced by X digits and transmit the share information.

The instruction part 12 instructs execution of processing of a man-flow analysis to the secret calculation servers 30 at a moment when the generation and transmission of the share information by the requesting part 11a above have been finished.

As is the case in the first exemplary embodiment, if distribution of secret calculation circuit (secret calculation program) according to the number of significant digits of a facial feature vector of facial feature data is not completed in advance, it is necessary for the distribution part 13 to generate and distribute a secret calculation circuit (secret calculation program).

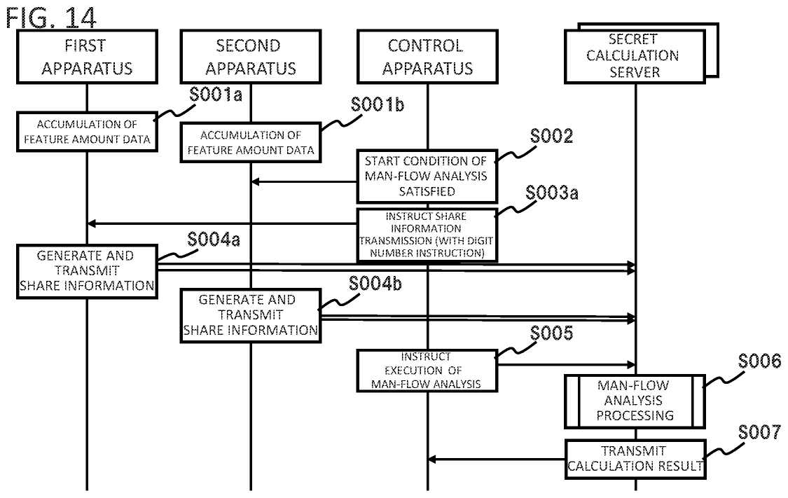

Subsequently, an operation of the present exemplary embodiment will be described in detail with reference to the drawings. FIG. 14 illustrates a sequence diagram showing an operation of the data analysis system according to the second exemplary embodiment of the present invention. In the following description, it is assumed that distribution of the secret calculation circuit (program) by the distribution part 13 has been completed. Because a basic flow is the same as that of the first exemplary embodiment, difference will be mainly described as below.

Difference of the sequence diagram from that of the first exemplary embodiment as shown in FIG. 6 is that, in step S003a, the number of significant digits of a facial feature vector of designated facial feature data is designated in a share information transmission instruction. Since other flows are the same as those of the first exemplary embodiment, the description will be omitted.

According to the present exemplary embodiment, it is possible to provide a result of a man-flow analysis which satisfies a required processing speed and processing precision. For example, it is possible to preferably apply the present exemplary embodiment to a use to grasp, within 15 minutes, a man-flow from a location 1 (first location) to a location 2 (second location) during the last 30 minutes to estimate required manpower to strengthen security of the location 2. Similarly, for example, it also is possible to preferably apply the present exemplary embodiment to a use to grasp, within 10 minutes, a man-flow from a location 2 (second location) to a location 1 (first location) during the last one hour to estimate required quantity of goods to be sold at an event site of the location 1.

In the above described exemplary embodiment, an example of reducing processing time by reducing the number of the digits of a feature vector of facial feature data is described but switching of processing contents is not limited to this. For example, it is possible to employ a mode to switch processing contents by removing some in a feature vector of facial feature data (reducing dimension of a vector). Furthermore, it is possible to shorten processing time by narrowing a time range of facial feature data to be collated. By using any one or more of these, a function of reducing data amount, a function of increasing speed of processing, or a function of reducing calculation amount can be achieved.

In addition to a viewpoint of shortening processing time, it is also assumed that there is a need to intentionally reduce precision used for determining identity of a person from a viewpoint of privacy protection. In this case, similarly, it is possible to reduce the precision used for determining identity of a person by switching processing contents, such as by removing some in a feature vector of facial feature data and/or reducing the number of significant digits.

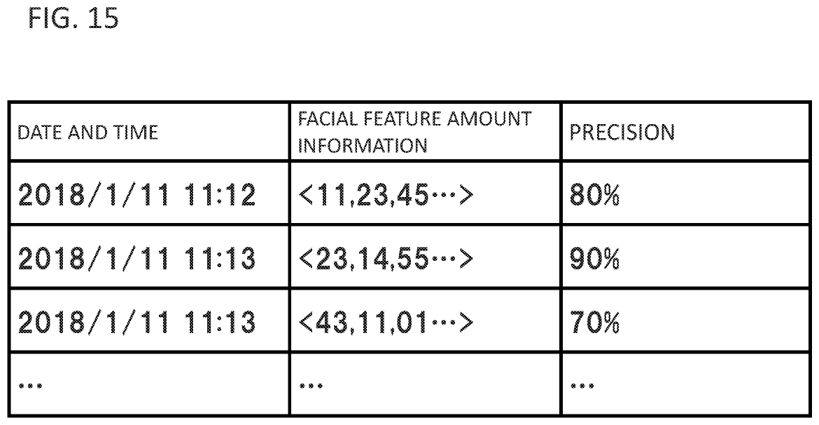

Furthermore, for example, as shown in FIG. 15, in a case where precision information (identification rate) is added to each facial feature data, it is possible to adjust processing speed and determination precision using the precision information. For example, because facial feature data of which precision (identification rate) is less than or equal to a predetermined value, of course, deteriorates precision of determining identity of a person, it is possible to increase processing speed of calculation with secret sharing by excluding such data from targets of collation. Furthermore, it is possible to adopt a method of reducing the number of significant digits of a feature vector of facial feature data whose precision (identification rate) is less than or equal to a predetermined value.

Furthermore, in a case where an amount of facial feature data transmitted from the first and second apparatuses is small, if determination of identity of a person is strictly performed, an individual is practically identified whereby a problem of privacy may occur. In such case, it is also effective to remove some among feature vectors of facial feature data or reduce the number of significant digits thereof as described above. Furthermore, in a case where an amount of facial feature data is small, it is possible not to perform (to omit) man-flow analysis processing.

As a method for estimating a processing speed as described above, it is possible to utilize a method of estimating processing speed by the number of data to be a target of collation, and the number of AND circuits of the above secret calculation circuit (program), or the like. Furthermore, it is also possible to estimate a processing speed based on an actual value of processing time of secret calculation implemented by using this system.

### THIRD EXEMPLARY EMBODIMENT

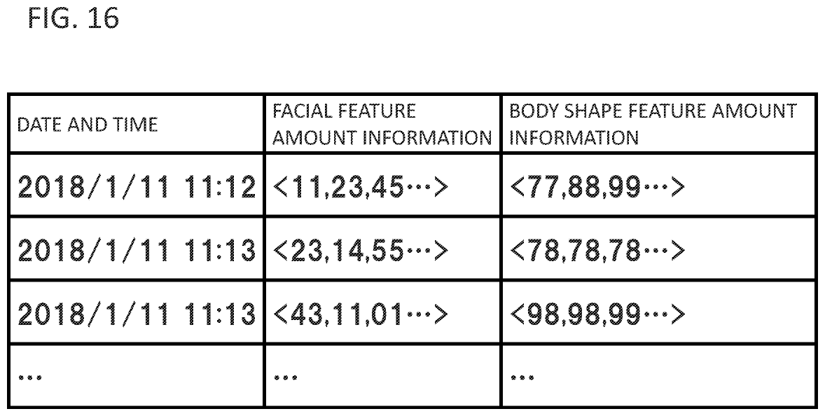

In the above described first and the second exemplary embodiments, determination of identity of a person is performed by using facial feature data, however, of course, determination of identity of a person may also be performed by using information other than facial feature data. For example, as shown in FIG. 16, in a case where the first and second apparatuses hold a feature amount of a body shape of a person (body shape feature data) in addition to facial feature data, it is also possible to determine identity of a person by using these concurrently.

By doing so, modification to increase precision of determination of identity of a person is possible. Furthermore, it is, of course, possible to perform determination of identity of a person using gait data indicating feature of manner of walking of a person in place of or in conjunction with the above feature amount of a body shape of a person (body shape feature data).

The exemplary embodiments of the present invention have been described as above, however, the present invention is not limited thereto. Further modifications, substitutions, or adjustments can be made without departing from the basic technical concept of the present invention. For example, the configurations of the networks and the elements and the representation modes of the messages illustrated in the individual drawings are merely used as examples to facilitate the understanding of the present invention. Thus, the present invention is not limited to the configurations illustrated in the drawings. In addition, “A and/or B” in the following description signifies at least one of A or B. While not illustrated, a port(s) or an interface(s) exists at an input-output connection point(s) in an individual block in the drawings.

For example, in the above described exemplary embodiments, it is described that facial feature data is used as identification information of a moving body, it is also possible to use biological information other than facial feature data and an ID of an equipment and so on as identification information of a moving body.

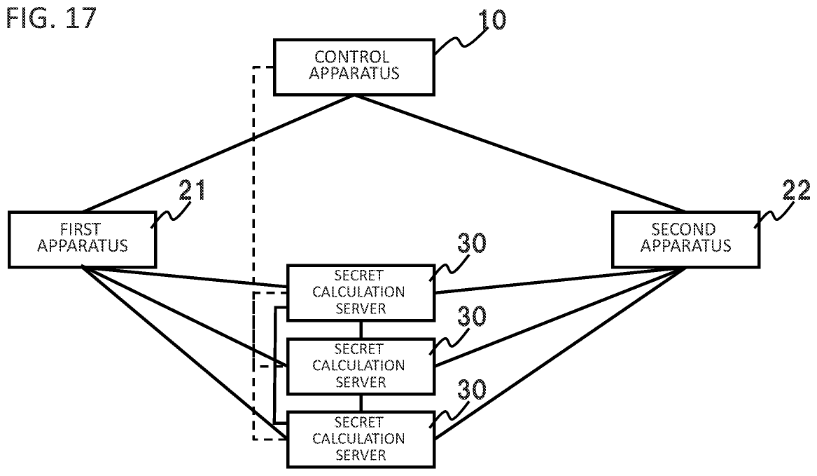

For example, in the above described exemplary embodiments, although an example using two secret calculation servers is described, three or more secret calculation servers may be used (refer to FIG. 17).

For example, in the above described exemplary embodiments, an example using a server to perform secret calculation with a secret sharing scheme as a secret calculation server is described, it is also possible to use a server which performs secret calculation using homomorphic encryption or fully homomorphic encryption and so on. The control apparatus 10, 10a requests the first and second apparatuses to transmit encrypted facial feature data to the secret calculation servers.

For example, in the above described exemplary embodiments, the control apparatus is described as being independently provided, the control apparatus may be included in any of the first apparatus or the second apparatus. Furthermore, the control apparatus may be included in any of the secret calculation servers.

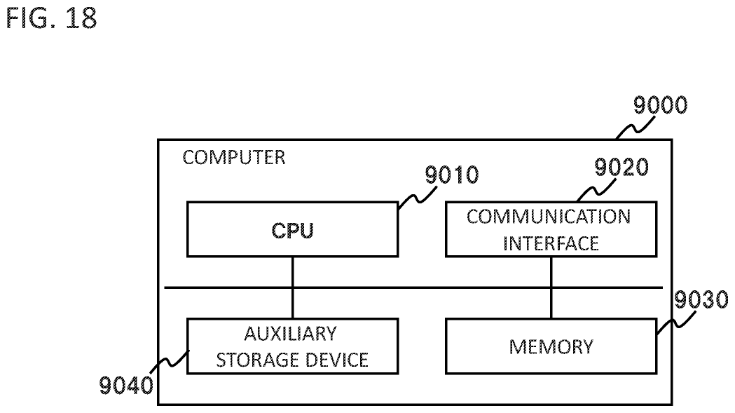

The procedures according to the first to third exemplary embodiments can be realized by a program that causes a computer (9000 in FIG. 18) functioning as an control apparatus 10, 10a to realize the function as the control apparatus 10, 10a. Such computer is illustrated by a configuration, as an example, including a CPU (central processing unit) 9010, a communication interface 9020, a memory 9030, and an auxiliary storage device 9040 in FIG. 18. Namely, the CPU 9010 in FIG. 18 may be configured to execute a program for requesting transmission of share information and a man-flow analysis instruction program and to perform processing for updating various calculation parameters stored in the auxiliary storage device 9040 or the like.

Namely, an individual part (processing means, function) of the control apparatus 10, 10a according to the above first to third exemplary embodiments may be realized by a computer program that causes a processor mounted in the control apparatus 10, 10a to perform the corresponding processing described above by using its hardware.

Finally, suitable modes of the present invention will be summarized.

### [Mode 1]

(See the control apparatus according to the above first aspect)

### [Mode 2]

In the above described control apparatus,

as the identification information of the first moving body and the identification information of the second moving body, it is possible to use facial feature data of a person taken by respective different cameras.

### [Mode 3]

In the above described control apparatus,

as the identification information of the first moving body and the identification information of the second moving body, it is possible to use data including body shape data of a person taken by respective different cameras.

### [Mode 4]

In the above described control apparatus,

as the identification information of the first moving body and the identification information of the second moving body, data which were obtained under respective different management entities is assumed.

### [Mode 5]

In the above described control apparatus,

it is possible to employ a configuration in which the predetermined secret calculation server(s) is(are) a plurality of secret calculation servers that perform calculation by a secret sharing scheme; and

the requesting part causes the first apparatus and the second apparatus to transmit share information which is converted from the identification information of the first moving body and the identification information of the second moving body to be secret-shared, to the secret calculation server(s).

### [Mode 6]

In the above described control apparatus,

as the predetermined calculation processing to be performed by the secret calculation server(s), it is preferable to cause the secret calculation server(s) to perform processing of calculating the number of a moving body(ies) that moved between the first location and the second location based on the identification information of the first moving body(ies) and the identification information of the second moving body(ies).

### [Mode 7]

In the above described control apparatus,

as the predetermined calculation processing to be performed by the secret calculation server(s), it is preferable to cause the secret calculation server(s) to perform processing of generating mobility data of a moving body that moved between the first location and the second location by collating the identification information of the first moving body with the identification information of the second moving body.

### [Mode 8]

In the above described control apparatus,

if the identification information of the first moving body and the identification information of the second moving body include time information that indicates a time on which the information was obtained,

as the predetermined calculation processing to be performed by the predetermined secret calculation server(s), it is also possible to cause the secret calculation server(s) to generate mobility data including a time-length required to move for a moving body which moved between the first location and the second location.

### [Mode 9]

In the above described control apparatus,

it is preferable that the mobility data is processed so that an individual cannot be identified.

### [Mode 10]

It is possible for the above described control apparatus to employ a configuration which include an adjusting part that switches contents of the calculation processing in order to satisfy a required processing time-length or a processing precision.

### [Mode 11]

The adjusting part can switch contents of the calculation processing by reducing feature amount data making up the identification information of the first moving body and the identification information of the second moving body.

### [Mode 12]

(See the data processing system according to the above second aspect)

### [Mode 13]

(See the secret calculation server control method according to the above third aspect)

### [Mode 14]

(See the computer program according to the above fourth aspect)

The above modes 12 to 14 can be expanded in the same way as mode 1 is expanded to modes 2 to 11.

The disclosure of each of the above Patent Literatures and Non-Patent Literature is incorporated herein by reference thereto. Variations and adjustments of the exemplary embodiments and examples are possible within the scope of the overall disclosure (including the claims) of the present invention and based on the basic technical concept of the present invention. Various combinations and selections (including partial deletion) of various disclosed elements (including the elements in each of the claims, exemplary embodiments, examples, drawings, etc.) are possible within the scope of the disclosure of the present invention. Namely, the present invention of course includes various variations and modifications that could be made by those skilled in the art according to the overall disclosure including the claims and the technical concept. In particular, with respect to the numerical ranges described herein, any numerical values or small range(s) included in the ranges should be construed as being expressly described even if not particularly mentioned.

### REFERENCE SIGNS LIST

10, 10a control apparatus
11, 11a requesting part
12 instruction part
13 distribution part
21, 21a first apparatus
22, 22a second apparatus
30 secret calculation server
111a adjusting part
211 camera
212 timer
213 feature amount extraction part
214 feature amount storage part
215 secret sharing part
216 digit number instruction receiving part
9000 computer
9010 CPU
9020 communication interface
9030 memory
9040 auxiliary storage device

What is claimed is:

1. A control apparatus, comprising:
at least a processor; and
a memory in circuit communication with the processor,
wherein the processor is configured to execute program instructions stored in the memory to implement:
a requesting part that requests each of a first apparatus holding identification information of a first moving body(ies) obtained at a first location and a second apparatus holding identification information of a second moving body(ies) obtained at a second location to provide the identification information of the first moving body(ies) and the identification information of the second moving body(ies) to a predetermined secret calculation server(s); and
an instruction part that instructs calculation processing relating to movement of a moving body(ies) based on the identification information of the first moving body(ies) and the identification information of the second moving body(ies) to the predetermined secret calculation server(s).

2. The control apparatus according to claim 1, wherein the identification information of the first moving body and the identification information of the second moving body include facial feature data of a person taken by respective different cameras.

3. The control apparatus according to claim 1, wherein the identification information of the first moving body and the identification information of the second moving body include body shape data of a person taken by respective different cameras.

4. The control apparatus according to claim 1 wherein the identification information of the first moving body and the identification information of the second moving body are data which were obtained under respective different management entities.

5. The control apparatus according to claim 1 wherein
the predetermined secret calculation server(s) is(are) a plurality of secret calculation servers that perform calculation by a secret sharing scheme; and
the requesting part causes the first apparatus and the second apparatus to transmit share information which is converted from the identification information of the first moving body and the identification information of the second moving body to be secret-shared, to the secret calculation server(s).

6. The control apparatus according to claim 1 wherein
the calculation processing is processing of calculating the number of a moving body(ies) that moved between the first location and the second location based on the identification information of the first moving body(ies) and the identification information of the second moving body(ies).

7. The control apparatus according to claim 1 wherein
the calculation processing is processing of generating mobility data of a moving body that moved between the first location and the second location by collating the identification information of the first moving body with the identification information of the second moving body.

8. The control apparatus according to claim 1 wherein
the identification information of the first moving body and the identification information of the second moving body include time information that indicates a time on which the information was obtained; and
the calculation processing is processing of generating mobility data including a time-length required to move for a moving body which moved between the first location and the second location.

9. The control apparatus according to claim 7, wherein the mobility data is processed so that an individual cannot be identified.

10. The control apparatus according to claim 6, wherein the processor is configured to execute the program instructions to implement:
that an adjusting part that switches contents of the calculation processing in order to satisfy a required processing time-length.

11. The control apparatus according to claim 6, wherein the processor is configured to execute the program instructions to implement:
that an adjusting part that switches contents of the calculation processing in order to satisfy a required processing precision.

12. The control apparatus according to claim 10, wherein the adjusting part dynamically switches contents of the calculation processing by reducing feature amount data making up the identification information of the first moving body and the identification information of the second moving body.

13. A data analysis system, comprising:
a predetermined secret calculation server(s); and
a control apparatus which comprises:
at least a processor; and
a memory in circuit communication with the processor,
wherein the processor is configured to execute program instructions stored in the memory to implement:
a requesting part that requests each of a first apparatus holding identification information of a first moving body(ies) obtained at a first location and a second apparatus holding identification information of a second moving body(ies) obtained at a second location to provide the identification information of the first moving body(ies) and the identification information of the second moving body(ies) to the predetermined secret calculation server(s); and
an instruction part that instructs calculation processing relating to movement of a moving body(ies) based on the identification information of the first moving body(ies) and the identification information of the second moving body(ies) to the predetermined secret calculation server(s).

14. A secret calculation server control method, comprising:
requesting each of a first apparatus holding identification information of a first moving body(ies) obtained at a first location and a second apparatus holding identification information of a second moving body(ies) obtained at a second location to provide the identification information of the first moving body(ies) and the identification information of the second moving body(ies) to a predetermined secret calculation server(s); and
instructing calculation processing relating to movement of a moving body(ies) based on the identification information of the first moving body(ies) and the identification information of the second moving body(ies) to the predetermined secret calculation server(s).

15. A computer-readable non-transient recording medium recording a computer program, the computer program that causes a control apparatus to execute processings, comprising:
requesting each of a first apparatus holding identification information of a first moving body(ies) obtained at a first location and a second apparatus holding identification information of a second moving body(ies) obtained at a second location to provide the identification information of the first moving body(ies) and the identification information of the second moving body(ies) to a predetermined secret calculation server(s); and
instructing calculation processing relating to movement of a moving body(ies) based on the identification information of the first moving body(ies) and the identification information of the second moving body(ies) to the predetermined secret calculation server(s).

16. The data analysis system according to claim 13, wherein
the calculation processing is processing of calculating the number of a moving body(ies) that moved between the first location and the second location based on the identification information of the first moving body(ies) and the identification information of the second moving body(ies).

17. The data analysis system according to claim 16, wherein the processor is configured to execute the program instructions to implement:
that an adjusting part that switches contents of the calculation processing in order to satisfy a required processing time-length.

18. The data analysis system according to claim 17, wherein the adjusting part dynamically switches contents of the calculation processing by reducing feature amount data making up the identification information of the first moving body and the identification information of the second moving body.

19. The method according to claim 14, wherein
the calculation processing is processing of calculating the number of a moving body(ies) that moved between the first location and the second location based on the identification information of the first moving body(ies) and the identification information of the second moving body(ies).

20. The method according to claim 19, further comprising:
adjusting to switch contents of the calculation processing in order to satisfy a required processing time-length.

21. The method according to claim 20, wherein the adjusting comprises dynamically switching contents of the calculation processing by reducing feature amount data making up the identification information of the first moving body and the identification information of the second moving body.

22. The medium according to claim 15, wherein
the calculation processing is processing of calculating the number of a moving body(ies) that moved between the first location and the second location based on the identification information of the first moving body(ies) and the identification information of the second moving body(ies).

23. The medium according to claim 22, wherein the computer program further causes the control apparatus to execute processing, comprising:
adjusting to switch contents of the calculation processing in order to satisfy a required processing time-length.

24. The medium according to claim 23, wherein the adjusting comprises dynamically switching contents of the calculation processing by reducing feature amount data making up the identification information of the first moving body and the identification information of the second moving body.
